(19) United States
(12) Patent Application Publication
(10) Pub. No.: US 2014/0351749 A1
(43) Pub. Date: Nov. 27, 2014

(54) METHODS, APPARATUSES AND COMPUTER PROGRAM PRODUCTS FOR MERGING AREAS IN VIEWS OF USER INTERFACES

(71) Applicants: Wei Wang, Beijing (CN); Qifeng Yan, Shenzhen (CN); Feng Zhou, Shenzhen (CN); Qian Cheng, Shenzhen (CN)

(72) Inventors: Wei Wang, Beijing (CN); Qifeng Yan, Shenzhen (CN); Feng Zhou, Shenzhen (CN); Qian Cheng, Shenzhen (CN)

(73) Assignee: NOKIA CORPORATION, Espoo (FI)

(21) Appl. No.: 14/364,975

(22) PCT Filed: Dec. 14, 2011
(86) PCT No.: PCT/CN2011/083979

§ 371 Date: Jun. 12, 2014

(51) Int. Cl. G06F 3/0485; H04M 1/725; G06F 3/0482; G06F 3/0487; G06F 3/0484; G06F 3/0481

(52) U.S. Cl. CPC G06F 3/0485; G06F 3/04842; G06F 3/04817; G06F 3/0482; G06F 3/0487; H04M 1/72583
USPC 715/799

(57) ABSTRACT

An apparatus for providing a user-friendly and reliable manner for management of objects of a user interface may include a processor and memory storing executable computer program code that cause the apparatus to at least perform operations including generating a merging area including one or more items of visible indicia corresponding to shortcuts to respective applications. The merging area may be arranged within a first area of a plurality of screens of a user interface. The computer program code may further cause the apparatus to enable moving of the merging area from the first area to a second area of the user interface in at least one screen of the plurality of screens to enable display of the merging area in response to detection, via the user interface, of a pointer moving the merging area to the second area. Corresponding methods and computer program products are also provided.

### TECHNOLOGICAL FIELD

An example embodiment of the invention relates generally to user interface technology and, more particularly, relates to a method, apparatus, and computer program product for providing a user-friendly and efficient manner in which to enable management of interactive objects via a user interface.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. Due to the now ubiquitous nature of electronic communication devices, people of all ages and education levels are utilizing electronic devices to communicate with other individuals or contacts, receive services and/or share information, media and other content. One area in which there is a demand to increase convenience to users relates to improving a user's ability to effectively interface with the user's communication device. Accordingly, numerous user interface mechanisms have been developed to attempt to enable a user to more easily accomplish tasks or otherwise improve the user's experience in using the device. In this regard, for example, a user's experience during certain applications such as, for example, web browsing or interactions with applications may be enhanced by using a touch screen display as the user interface.

For instance, the user interface may have application launchers in a home screen area of the user interface that typically provides a user with a way of launching, switching between, and monitoring the execution of programs or applications. These applications may be represented as displayed icons in which access is provided to functions of a communication device that may interact with an operating system.

At present, typical operating systems of smart communication devices may allow some customization layout of interactive objects of a user interface. However, at present, it may be difficult for a user to organize huge icons and widgets in a home screen and/or a main menu of a user interface of a communication device. Meanwhile, the same application or program may have different visual variants in different views. For example, an icon and a widget may be utilized to point to a same application but may be quite different in their visualization. In this regard, these visual variants may lack a tangible relationship for user understanding. As such, a user may not recognize that these different visualizations relate to the same application or program.

Although, at present, operation systems of smart communication devices allow some customization layout of icons and widgets, these existing operating systems may have some drawbacks. For example, some operating systems may allow a user to manage items in a home screen or main menu of a smart communication device in an organize mode. However, the user may only be able to manage items (e.g., icons, shortcuts) in a current level of a user interface or view and the manner in which to enable editing of the items may not be very intuitive or user friendly. For instance, a long tap to create a pop-up menu for selection of an icon or alternatively to select a new icon from a long list may be required. Also, in some current operating systems such as, for example, Android™, a user may be able to add widgets in a home menu but may lack the continuity and smoothness between a same entity's (e.g., an application) different visual variants (e.g., an icon, a widget) in different views of a user interface.

In addition, some existing operating systems such as, for example, the iPhone™ Operating System (iOS)™, may allow a user to use an icon panel 3 in the bottom of a home area, as shown in FIG. 1. The home area may include views to favorite application shortcuts of a user in the icon panel 3. However, the iOS™ does not typically provide continuity between a same entity's (e.g., an application) different visual variants (e.g., an icon and a widget corresponding the same application) in different user interface views or levels. For instance, the iOS™ typically may not provide a manner in which to allow application shortcuts (e.g., an icon) of the icon panel 3 to change form and be represented differently (e.g., as a widget) for a same application (e.g., a short message service (SMS) application (e.g., a text message application). Additionally, the icon panel 3 of the iOS™ is typically not movable to different areas of the user interface. Instead, it generally remains fixed at the bottom of a home area of a user interface, even in instances in which different views of a user interface are accessed. In this regard, the iOS™ may lack some flexibility in allowing the user to manage or organize the icon panel as well as managing the organization of applications in different views of a user interface.

In view of the foregoing drawbacks, it may be desirable to provide an alternative mechanism in which to enable objects of a user interface to be more efficiently managed and utilized in different views of a user interface.

### SUMMARY

A method, apparatus and computer program product are therefore provided for providing a user-friendly, efficient and reliable manner in which to enable management of objects via a user interface of a communication device.

An example embodiment may provide a touchable user interface structure having different levels including, but not limited to, an idle screen, a home screen, an application (e.g., shell) screen, a main menu screen to applications of the user interface, etc. Additionally, an example embodiment of the invention may provide a user some freedom to customize layout, organize icon buttons, widgets, shortcut and other interactive objects in and between different user interface views, screens, or levels. An example embodiment may provide a manner in which to enable a user to manage user interface objects and to maintain continuity between a merging area(s) of various views of a user interface.

An example embodiment of the invention may designate a part of a screen space/area of a user interface as a merging area between different user interface views. In this regard, the merging area may be displayed in an upper or lower view of a user interface as well as a previous or next view of a user interface. The merging area of the user interface may be utilized in a continuous flow by a user to enable sharing of objects and functions, for example. In this manner, an example embodiment may enable the merging area to facilitate sharing of particular functional attribute(s) with multiple views of the user interface. The location of the merging area may be different in a specific view based in part on a user interface transition, for example.

By utilizing example embodiments of the invention, users may interact with user interface objects between a merging area and another space or area of a screen(s) of a user interface to organize the user interface. For instance, a user may interact with user interface objects between a merging area and another space of the screen to organize a user interface. In some example embodiments, utilization of the merging area may enable a user to switch between different applications.

In one example embodiment, a method for providing a user-friendly and reliable manner for management of objects of a user interface is provided. The method may include generating a merging area including one or more items of visible indicia corresponding to shortcuts to respective applications. The merging area may be arranged within a first area of a plurality of screens of a user interface. The method may further include enabling moving of the merging area from the first area to a second area of the user interface in at least one screen of the screens to enable display of the merging area in response to detection, via the user interface, of a pointer moving the merging area to the second area.

In another example embodiment, an apparatus for providing a user-friendly and reliable manner for management of objects of a user interface is provided. The apparatus may include a processor and a memory including computer program code. The memory and the computer program code are configured to, with the processor, cause the apparatus to at least perform operations including generating a merging area including one or more items of visible indicia corresponding to shortcuts to respective applications. The merging area may be arranged within a first area of a plurality of screens of a user interface. The memory and the computer program code may further cause the apparatus to enable moving of the merging area from the first area to a second area of the user interface in at least one screen of the screens to enable display of the merging area in response to detection, via the user interface, of a pointer moving the merging area to the second area.

In another example embodiment, a computer program product for providing a user-friendly and reliable manner for management of objects of a user interface is provided. The computer program product includes at least one computer-readable storage medium having computer-executable program code instructions stored therein. The computer executable program code instructions may include program code instructions configured to generate a merging area including one or more items of visible indicia corresponding to shortcuts to respective applications. The merging area may be arranged within a first area of a plurality of screens of a user interface. The program code instructions may also enable moving of the merging area from the first area to a second area of the user interface in at least one screen of the screens to enable display of the merging area in response to detection, via the user interface, of a pointer moving the merging area to the second area.

In another example embodiment, an apparatus for providing a user-friendly and reliable manner for management of objects of a user interface is provided. The apparatus includes means for generating a merging area including one or more items of visible indicia corresponding to shortcuts to respective applications. The merging area may be arranged within a first area of a plurality of screens of a user interface. The apparatus may also include means for enabling moving of the merging area from the first area to a second area of the user interface in at least one screen of the screens to enable display of the merging area in response to detection, via the user interface, of a pointer moving the merging area to the second area.

An example embodiment of the invention may provide a better user experience given the ease and efficiency in enabling management of objects via a user interface. As a result, device users may enjoy improved capabilities with respect to applications and services accessible via the device.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a home screen including an icon panel;

FIG. 2 is a schematic block diagram of a system according to an example embodiment of the invention;

FIG. 3 is a schematic block diagram of an apparatus according to an example embodiment of the invention;

FIGS. 4A, 4B, 4C and 4D are diagrams illustrating screens of a user interface according to an example embodiment of the invention;

FIGS. 5A and 5B are diagrams illustrating switching of items between a shortcut merging area and another area of a main menu of a user interface according to an example embodiment of the invention; and

FIGS. 6A and 6B are schematic block diagrams of apparatuses including user interfaces with a shared merging area according to an example embodiment of the invention;

FIGS. 7A and 7B are schematic block diagrams of apparatuses including user interfaces with a shared merging area according to another example embodiment of the invention; and

FIG. 8 illustrates a flowchart for providing a user-friendly, efficient and reliable manner in which to enable management of one or more objects of a user interface according to an example embodiment of the invention.

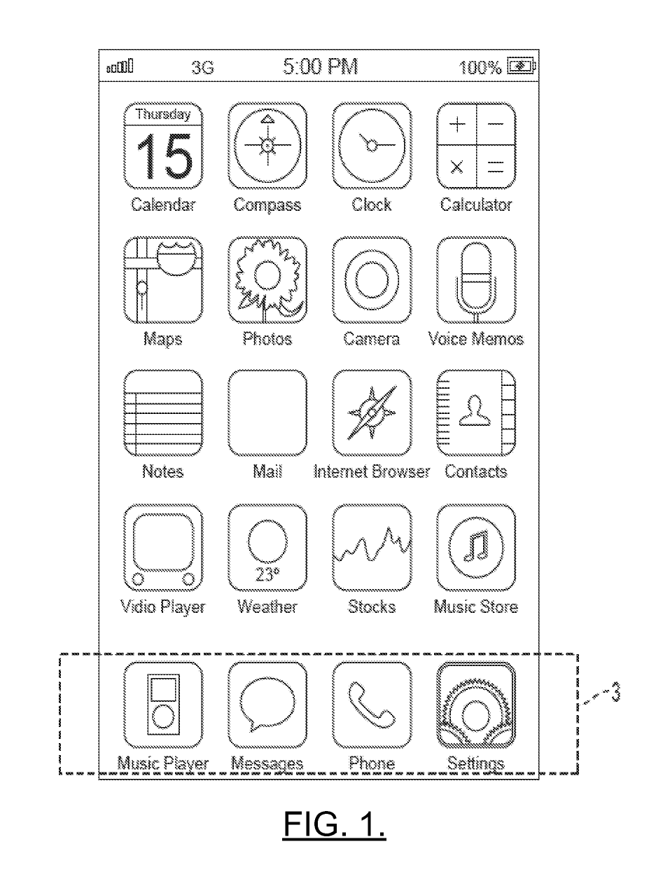

### DETAILED DESCRIPTION

Some embodiments of the invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a merging area may, but need not be, an area of a user interface that maintains shortcuts to applications (e.g., designated applications, default applications, favorite applications, etc.), which may be visible both in one or more screens (e.g., a home screen, an application screen (also referred to herein as application view, etc.) of a user interface and which may, but need not, serve as a link between the screens. The relationship of the link may, but need not, be based on (1) the previous/next steps in a use flow, (2) the upper/lower levels in a hierarchical structure, or (3) other similarities such as operating a same type of content or information.

As referred to herein, a pointer(s) may include, but is not limited to, one or more body parts such as, for example, a finger(s), a hand(s) etc., or a mechanical and/or electronic pointing device(s) (e.g., a stylus, pen, mouse, joystick, etc.) configured to enable a user(s) to input items of data to a communication device.

As referred to herein, a home screen, an idle screen or an auto-screen, may be a screen of a user interface that is initially enabled for display via a device of a user interface in an instance in which the device is turned on and which may remain as an active screen of the user interface even after the device is turned on.

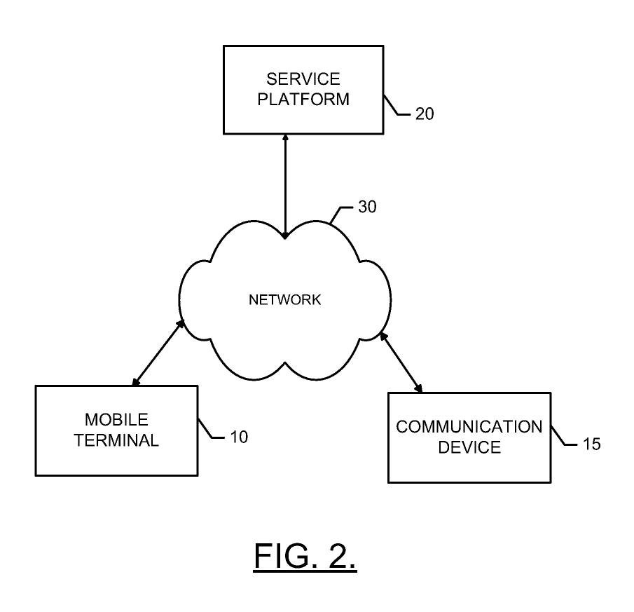

FIG. 2 illustrates a block diagram of a system that may benefit from an embodiment of the invention. It should be understood, however, that the system as illustrated and hereinafter described is merely illustrative of one system that may benefit from an example embodiment of the invention and, therefore, should not be taken to limit the scope of embodiments of the invention. As shown in FIG. 2, an embodiment of a system in accordance with an example embodiment of the invention may include a mobile terminal 10 capable of communication with numerous other devices including, for example, a service platform 20 via a network 30. In one embodiment of the invention, the system may further include one or more additional communication devices (e.g., communication device 15) such as other mobile terminals, personal computers (PCs), servers, network hard disks, file storage servers, and/or the like, that are capable of communication with the mobile terminal 10 and accessible by the service platform 20. However, not all systems that employ an embodiment of the invention may comprise all the devices illustrated and/or described herein. Moreover, in some cases, an embodiment may be practiced on a standalone device independent of any system.

The mobile terminal 10 may be any of multiple types of mobile communication and/or computing devices such as, for example, portable digital assistants (PDAs), pagers, mobile televisions, mobile telephones, gaming devices, wearable devices, head mounted devices, laptop computers, touch surface devices, cameras, camera phones, video recorders, audio/video players, radios, global positioning system (GPS) devices, or any combination of the aforementioned, and other types of voice and text communications systems. The network 30 may include a collection of various different nodes, devices or functions that may be in communication with each other via corresponding wired and/or wireless interfaces. As such, the illustration of FIG. 2 should be understood to be an example of a broad view of certain elements of the system and not an all inclusive or detailed view of the system or the network 30.

Although not necessary, in some embodiments, the network 30 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE), LTE advanced (LTE-A) and/or the like. Thus, the network 30 may be a cellular network, a mobile network and/or a data network, such as a Local Area Network (LAN), a Metropolitan Area Network (MAN), and/or a Wide Area Network (WAN), e.g., the Internet. In turn, other devices such as processing elements (e.g., personal computers, server computers or the like) may be included in or coupled to the network 30. By directly or indirectly connecting the mobile terminal 10 and the other devices (e.g., service platform 20, or other mobile terminals or devices such as the communication device 15) to the network 30, the mobile terminal 10 and/or the other devices may be enabled to communicate with each other, for example, according to numerous communication protocols, to thereby carry out various communication or other functions of the mobile terminal 10 and the other devices, respectively. As such, the mobile terminal 10 and the other devices may be enabled to communicate with the network 30 and/or each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as Wireless LAN (WLAN), Worldwide Interoperability for Microwave Access (WiMAX), WiFi, Ultra-Wide Band (UWB), Wibree techniques and/or the like and fixed access mechanisms such as Digital Subscriber Line (DSL), cable modems, Ethernet and/or the like.

In an example embodiment, the service platform 20 may be a device or node such as a server or other processing element. The service platform 20 may have any number of functions or associations with various services. As such, for example, the service platform 20 may be a platform such as a dedicated server (or server bank) associated with a particular information source or service (e.g., a service associated with provision of content elements (e.g., applications, widgets, etc.)), or the service platform 20 may be a backend server associated with one or more other functions or services. As such, the service platform 20 represents a potential host for a plurality of different services or information sources. In one embodiment, the functionality of the service platform 20 is provided by hardware and/or software components configured to operate in accordance with known techniques for the provision of information to users of communication devices. However, at least some of the functionality provided by the service platform 20 may be data processing and/or service provision functionality provided in accordance with an example embodiment of the invention.

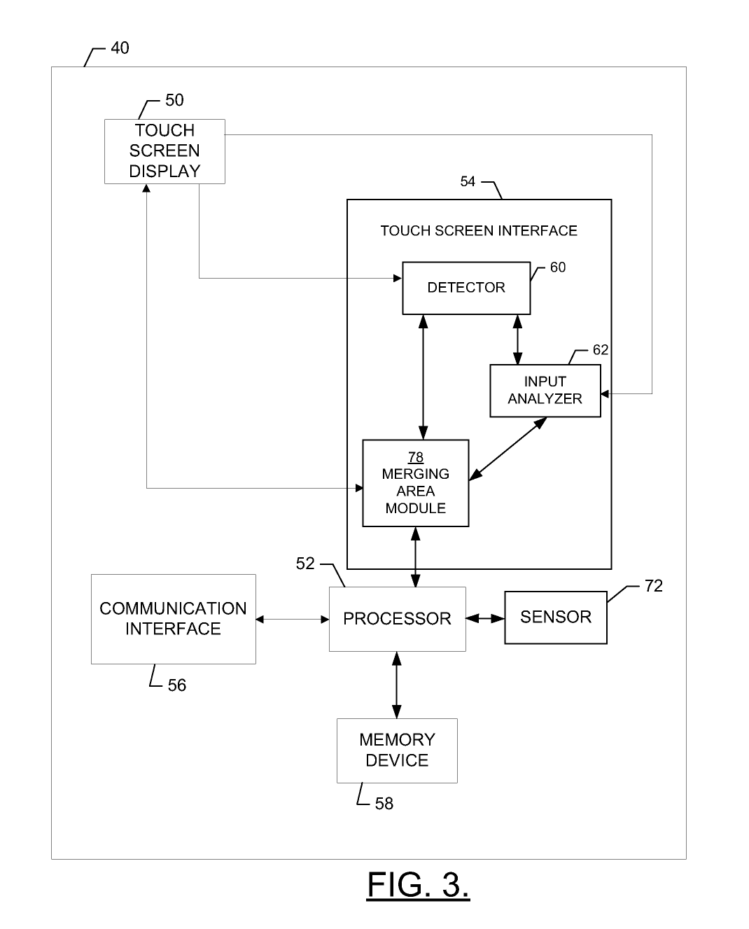

In an example embodiment, the mobile terminal 10 may employ an apparatus (e.g., the apparatus 40 of FIG. 3) capable of employing an embodiment of the invention. Moreover, the communication device 15 may also implement an embodiment of the invention.

FIG. 3 illustrates a schematic block diagram of an apparatus for employing a user-friendly input interface in communication with a touch screen display that enables efficient and reliable management of objects according to an example embodiment of the invention. An example embodiment of the invention will now be described with reference to FIG. 3, in which certain elements of an apparatus 40 are displayed. The apparatus 40 of FIG. 3 may be employed, for example, on the mobile terminal 10 (and/or the communication device 15). Alternatively, the apparatus 40 may be embodied on a network device of the network 30. However, the apparatus 40 may alternatively be embodied at a variety of other devices, both mobile and fixed (such as, for example, any of the devices listed above). In some cases, an embodiment may be employed on a combination of devices. Accordingly, one embodiment of the invention may be embodied wholly at a single device (e.g., the mobile terminal 10), by a plurality of devices in a distributed fashion (e.g., on one or a plurality of devices in a point-to-point (P2P) network) or by devices in a client/server relationship. Furthermore, it should be noted that the devices or elements described below may not be mandatory and thus some may be omitted in a certain embodiment.

Referring now to FIG. 3, the apparatus 40 may include or otherwise be in communication with a touch screen display 50, a processor 52, a touch screen interface 54, a communication interface 56, a memory device 58, a sensor 72, an input analyzer 62, a detector 60 and a merging area module 78. The memory device 58 may include, for example, volatile and/or non-volatile memory. For example, the memory device 58 may be an electronic storage device (e.g., a computer readable storage medium) comprising gates configured to store data (e.g., bits) that may be retrievable by a machine (e.g., a computing device like processor 52). In an example embodiment, the memory device 58 may be a tangible memory device that is not transitory. The memory device 58 may be configured to store information, data, files, applications, instructions or the like for enabling the apparatus to carry out various functions in accordance with an example embodiment of the invention. The memory device 58 may also store data associated with objects, including but not limited to, visible indicia corresponding to icons, buttons, widgets, shortcuts or the like. For example, the memory device 58 could be configured to buffer input data for processing by the processor 52. Additionally or alternatively, the memory device 58 could be configured to store instructions for execution by the processor 52. As yet another alternative, the memory device 58 may be one of a plurality of databases that store information and/or media content (e.g., pictures, videos, etc.).

The apparatus 40 may, in one embodiment, be a mobile terminal (e.g., mobile terminal 10) or a fixed communication device or computing device configured to employ an example embodiment of the invention. However, in one embodiment, the apparatus 40 may be embodied as a chip or chip set. In other words, the apparatus 40 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 40 may therefore, in some cases, be configured to implement an embodiment of the invention on a single chip or as a single “system on a chip.” As such, in some cases, a chip or chipset may constitute means for performing one or more operations for providing the functionalities described herein. Additionally or alternatively, the chip or chipset may constitute means for enabling user interface navigation with respect to the functionalities and/or services described herein.

The processor 52 may be embodied in a number of different ways. For example, the processor 52 may be embodied as one or more of various processing means such as a coprocessor, microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, or the like. In an example embodiment, the processor 52 may be configured to execute instructions stored in the memory device 58 or otherwise accessible to the processor 52. As such, whether configured by hardware or software methods, or by a combination thereof, the processor 52 may represent an entity (e.g., physically embodied in circuitry) capable of performing operations according to an embodiment of the invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor 52 to perform the algorithms and operations described herein when the instructions are executed. However, in some cases, the processor 52 may be a processor of a specific device (e.g., a mobile terminal or network device) adapted for employing an embodiment of the invention by further configuration of the processor 52 by instructions for performing the algorithms and operations described herein. The processor 52 may include, among other things, a clock, an arithmetic logic unit (ALU) and logic gates configured to support operation of the processor 52.

In an example embodiment, the processor 52 may be configured to operate a connectivity program, such as a browser, Web browser or the like. In this regard, the connectivity program may enable the apparatus 40 to transmit and receive Web content, such as for example location-based content or any other suitable content, according to a Wireless Application Protocol (WAP), for example. It should be pointed out that the processor 52 may also be in communication with the touch screen display 50 and may instruct the display to illustrate any suitable information, data, content (e.g., media content) or the like.

Meanwhile, the communication interface 56 may be any means such as a device or circuitry embodied in either hardware, a computer program product, or a combination of hardware and software that is configured to receive and/or transmit data from/to a network and/or any other device or module in communication with the apparatus 40. In this regard, the communication interface 56 may include, for example, an antenna (or multiple antennas) and supporting hardware and/or software for enabling communications with a wireless communication network (e.g., network 30). In fixed environments, the communication interface 56 may alternatively or also support wired communication. As such, the communication interface 56 may include a communication modem and/or other hardware/software for supporting communication via cable, Digital Subscriber Line (DSL), Universal Serial Bus (USB), Ethernet, High-Definition Multimedia Interface (HDMI) or other mechanisms. Furthermore, the communication interface 56 may include hardware and/or software for supporting communication mechanisms such as Bluetooth, Infrared, Ultra-Wideband (UWB), WiFi and/or the like.

The touch screen display 50 may be configured to enable touch recognition by any suitable technique, such as resistive, capacitive, infrared, strain gauge, surface wave, optical imaging, dispersive signal technology, acoustic pulse recognition, or other like techniques. The touch screen display 50 may also detect pointer (e.g., finger) movements just above the touch screen display even in an instance in which the pointer (e.g., finger) may not actually touch the touch screen of the display 50. The touch screen interface 54 may be in communication with the touch screen display 50 to receive indications of user inputs at the touch screen display 50 and to modify a response to such indications based on corresponding user actions that may be inferred or otherwise determined responsive to the indications. In this regard, the touch screen interface 54 may be any device or means embodied in either hardware, software, or a combination of hardware and software configured to perform the respective functions associated with the touch screen interface 54 as described below. In an example embodiment, the touch screen interface 54 may be embodied in software as instructions that are stored in the memory device 58 and executed by the processor 52. Alternatively, the touch screen interface 54 may be embodied as the processor 52 configured to perform the functions of the touch screen interface 54.

The touch screen interface 54 may be configured to receive an indication of an input in the form of a touch event at the touch screen display 50. Following recognition of the touch event, the touch screen interface 54 may be configured to thereafter determine a stroke event or other input gesture and provide a corresponding indication on the touch screen display 50 based on the stroke event. In this regard, for example, the touch screen interface 54 may include a detector 60 to receive indications of user inputs in order to recognize and/or determine a touch event based on each input received at the detector 60.

In an example embodiment, one or more sensors (e.g., sensor 72) may be in communication with the detector 60. The sensors may be any of various devices or modules configured to sense one or more conditions. In this regard, for example, a condition(s) that may be monitored by the sensor 72 may include pressure (e.g., an amount of pressure exerted by a touch event) and any other suitable parameters (e.g., an amount of time in which the touch screen of the display 50 was pressed (e.g., a long press, a swipe), or a size of an area of the touch screen of the display 50 that was pressed).

A touch event may be defined as a detection of a pointer (e.g., an object, such as a stylus, finger, pen, pencil or any other pointing device), coming into contact with a portion of the touch screen display in a manner sufficient to register as a touch (or registering of a detection of an object just above the touch screen display (e.g., hovering of a finger). In this regard, for example, a touch event could be a detection of pressure on the screen of touch screen display 50 above a particular pressure threshold over a given area. In one alternative embodiment, a touch event may be a detection of pressure on the screen of touch screen display 50 above a particular threshold time. Subsequent to each touch event, the touch screen interface 54 (e.g., via the detector 60) may be further configured to recognize and/or determine a corresponding stroke event or input gesture. A stroke event (which may also be referred to as an input gesture) may be defined as a touch event followed immediately by motion of the object initiating the touch event while the object remains in contact with the touch screen display 50. In other words, the stroke event or input gesture may be defined by motion following a touch event thereby forming a continuous, moving touch event defining a moving series of instantaneous touch positions. The stroke event or input gesture may represent a series of unbroken touch events, or in some cases a combination of separate touch events. For purposes of the description above, the term immediately should not necessarily be understood to correspond to a temporal limitation. Rather, the term immediately, while it may generally correspond to relatively short time after the touch event in many instances, instead is indicative of no intervening actions between the touch event and the motion of the object defining the touch positions while such object remains in contact with the touch screen display 50. In this regard, it should be pointed out that no intervening actions cause operation or function of the touch screen. However, in some instances in which a touch event that is held for a threshold period of time triggers a corresponding function, the term immediately may also have a temporal component associated in that the motion of the object causing the touch event must occur before the expiration of the threshold period of time.

In an example embodiment, the detector 60 may be configured to communicate detection information regarding the recognition or detection of a stroke event or input gesture as well as a selection of one or more items of data (e.g., images, text, graphical elements, etc.) to an input analyzer 62. The input analyzer 62 may communicate with a merging area module 78. In one embodiment, the input analyzer 62 (along with the detector 60) may be a portion of the touch screen interface 54. In an example embodiment, the touch screen interface 54 may be embodied by a processor, controller of the like. Furthermore, the input analyzer 62 and the detector 60 may each be embodied as any means such as a device or circuitry embodied in hardware, software or a combination of hardware and software that is configured to perform corresponding functions of the input analyzer 62 and the detector 60, respectively.

The input analyzer 62 may be configured to compare an input gesture or stroke event to various profiles of previously received or predefined input gestures and/or stroke events in order to determine whether a particular input gesture or stroke event corresponds to a known or previously received input gesture or stroke event. If a correspondence is determined, the input analyzer may identify the recognized or determined input gesture or stroke event to the merging area module 78. In one embodiment, the input analyzer 62 is configured to determine stroke or line orientations (e.g., vertical, horizontal, diagonal, etc.) and various other stroke characteristics such as length, curvature, shape, and/or the like. The determined characteristics may be compared to characteristics of other input gestures either of this user or generic in nature, to determine or identify a particular input gesture or stroke event based on similarity to know input gestures.

In an example embodiment, the processor 52 may be embodied as, include or otherwise control the merging area module 78. The merging area module 78 may be any means such as a device or circuitry operating in accordance with software or otherwise embodied in hardware or a combination of hardware and software (e.g., processor 52 operating under software control, the processor 52 embodied as an ASIC or FPGA specifically configured to perform the operations described herein, or a combination thereof) thereby configuring the device or structure to perform the corresponding functions of the merging area module 78, as described below. Thus, in an example in which software is employed, a device or circuitry (e.g., the processor 52 in one example) executing the software forms the structure associated with such means.

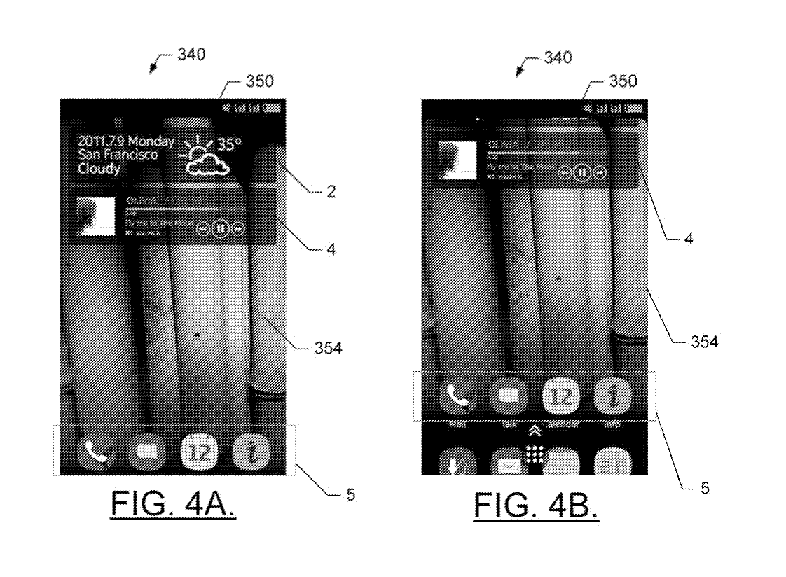

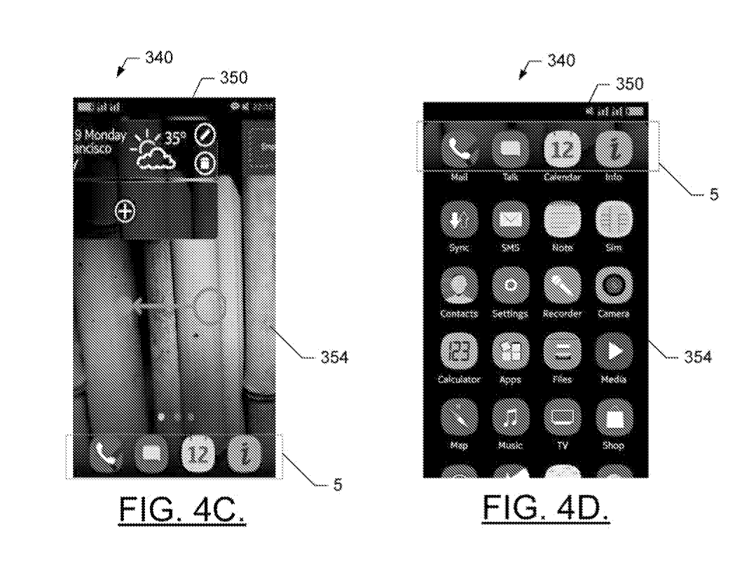

The merging area module 78 may communicate with the detector 60 and the input analyzer 62. The merging area module 78 (also referred to herein as application launcher 78) may generate a merging area (e.g., merging area 5 of FIGS. 4A, 4B, 4C). The merging area generated by the merging area module 78 may include one or more items of visible indicia such as, for example, icons associated with applications. In response to receipt of an indication of an indication of a selection of an item of visible indicia (e.g., icons) of the merging area, the merging area module 78 may quickly find and/or launch a corresponding application(s). In this regard, the merging area may provide access to applications, programs and files or the like of the apparatus 40.

The items of visible indicia of the merging area generated by the merging area module 78 may be indexed as shortcuts to allow quicker access to applications, programs, files, or the like without requiring opening of specific folder(s), menu(s) or the like for accessing the application(s), program(s), file(s), etc. The items of visible indicia of the merging area may, but need not, be associated with one or more favorite applications of a user of the apparatus 40.

In an example embodiment, the merging area module 78 may generate a merging area as part of the touch screen interface 54. The merging area (e.g., merging area 5 of FIGS. 4A, 4B, 4B) generated by the merging area module 78 may associated with or linked to views or levels (also referred to herein as screens, or virtual pages) of touch screen interface 54. In this manner, the merging area module 78 may generate a merging area for display. The merging area may be movable, by the merging area module 78 to any suitable portion (e.g., an upper portion, a middle portion, a lower portion in a vertical direction, a left portion, a right portion in a horizontal direction, etc.) of a screen (e.g., a home screen, etc.) of a touch screen interface 54. The merging area module 78 may move a merging area in response to receipt of an indication of a selection, by a pointer, of a portion of a merging area being moved across the touch screen interface 54.

Additionally, the merging area module 78 may generate the merging area to enable the merging area to be accessible and viewable via a previously accessed view (e.g., screen) of the touch screen interface 54 as well as a view of a home screen to enable continuity between different views of the touch screen interface 54. The merging area may be viewable in a same position (e.g., at a bottom position, a middle position, a top position, etc.) of the previously accessed screen as well as the home screen and any other suitable screens. The previously accessed view may, for example, be a screen of the touch screen interface 54 preceding a home screen of the touch screen interface 54. Moreover, the merging area module 78 may generate a merging area that is accessible via a screen of the touch screen interface 54 that is next or subsequent to a home screen of the touch screen interface 54 to enable a merging area to be viewable in a same position of a home screen as well as the next or subsequent views, or any other views, of the touch screen interface 54. Moreover, the merging area module 78 may enable a merging area to be moved to different areas of a home screen or any other screen of the touch screen interface 54 which may be displayed by the touch screen display 50. In this regard, by enabling the merging area to be displayed via the touch screen display 50 in a home screen of the touch screen interface 54 as well as a previous, next or subsequent screens of the touch screen interface 54, the merging area module 78 may maintain continuity between different user interface views. In this manner, the merging area may share a particular functional attribute in multiple views of the touch screen interface and may provide flexibility to the user to manage the objects of the user interface.

Additionally, the merging area module 78 may enable a selected item(s) of visible indicia (e.g., icons) in a portion of a screen of the touch screen interface 54 to be moved into the merging area which may replace an item of visible indicia (e.g., an icon) of the merging area with the item of visible indicia being moved into the merging area. The item(s) of visible indicia being replaced in the merging area may be moved by the merging area module to the location in which the items being moved to the merging area previously occupied in a screen of the touch screen interface, as described more fully below.

Referring now to FIGS. 4A, 4B, 4C, and 4D, diagrams illustrating merging areas of a user interface according to an example embodiment are provided. In an example embodiment, the merging areas of FIGS. 4A, 4B, 4C and 4D may be generated by a merging area module (e.g., merging area module 78) of an apparatus 340 (e.g., apparatus 40). In the example embodiment of FIG. 4A, the merging area module may generate a merging area 5 (e.g., an application launcher) which may include one or more items of visible indicia (e.g., icons) corresponding to applications. For instance, the items of visible indicia of the merging area 5 may point, or be linked, to the applications. As such, in one example embodiment, the items of visible indicia of the merging area 5 may be shortcuts to applications. In an instance in which the merging area module and/or a processor (e.g., merging area module 78 and/or processor 52) detects a selection of an item of visible indicia of the merging area 5, the merging area module and/or a processor (e.g., merging area module 78 and/or processor 52) of the apparatus 340 may execute the corresponding application.

In the example of FIG. 4A, the merging area 5 is part of a home screen (also referred to herein as an idle screen or auto screen) or a touch screen interface 354 (e.g., touch screen interface 54) displayed via a touch screen display 350 (e.g., touch screen display 50). The touch screen interface 354 may also include one or more widgets. For instance, in the example embodiment of FIG. 4A, the touch screen interface 354 may include a weather widget 2 and a music widget 4. However, in some other alternative example embodiments, any suitable number of widgets may be included in the touch screen interface 354 of FIG. 4A.

In the example embodiment of FIG. 4B, the merging area module (e.g., merging area module 78) may move the merging area 5 to a different area of the touch screen interface 354 (e.g., a home screen of the touch screen interface 354) in response to receipt of a selection of the merging area 5 by a pointer. In this regard, the merging area module may move the merging area 5 across an area(s) of the touch screen interface 354 as the pointer is sliding the merging area 5 across the touch screen interface 354. As such, in the example embodiment of FIG. 4B, the merging area 5 may be moved by the merging area module to a portion of the touch screen interface 354 other than a displayable bottom portion/area of the touch screen interface 354. However, in other example embodiments the merging area 5 may be moved to a bottom portion of the touch screen interface. In this example embodiment, the merging area module may move the merging area 5 vertically above a row of items of visible indicia (e.g., icons) in response to detecting that a pointer is dragging the merging area 5 vertically above the row of the items of visible indicia (e.g., icons). In an instance in which the merging area module (e.g., merging area module 78) detects that the pointer releases the merging area after the merging area 5 is moved, the merging area module may position the merging area 5 at the corresponding location of the touch screen interface 354 in which the pointer was released. As such, in one example embodiment, in an instance in which the merging area module detects that a pointer moves (e.g., scrolls) the home screen of touch screen interface 354 of FIG. 4B up or down, the merging area module may maintain the location/position of the merging area 5 on the touch screen interface 354. In this regard, in an instance in which a pointer exerts enough force to move the home screen of the touch screen interface 354 of FIG. 4B a certain distance, such that the position of the merging area 5 is off the screen of the touch screen display 350, the merging area 5 may not be displayed, even though the position of the merging area is kept intact on the touch screen interface 354.

Additionally, in an instance in which a pointer is moved or scrolls to the left or right of the home screen to access previous or subsequent screens/views of the touch screen interface 354, the merging area 5 may maintain continuity with the home screen and the merging area module may enable the merging area 5 to keep the same position on the newly accessed screen as the position of the merging area 5 on the home screen. In this regard, the merging area 5 and its items of visible indicia (e.g., icons) may be shared between multiple different screens/views of the touch screen interface 354.

Referring now to FIG. 4C, a diagram of a user interface according to an example embodiment is provided. In the example embodiment of FIG. 4C, the merging area module and/or a detector (e.g. detector 60) may detect a pointer scrolling multiple home screens in a horizontal direction but the merging area module may keep merging area 5 in a same position in the multiple home screens.

In the example embodiment of FIG. 4D, the merging area module may move the merging area 5 to a top area of the home screen of the touch screen interface 354 in response to detecting that a pointer moved the merging area 5 to the top area. In one example embodiment, the screen of the touch screen interface 354 of FIG. 4D may, but need not, be a main menu of the of the touch screen interface 354.

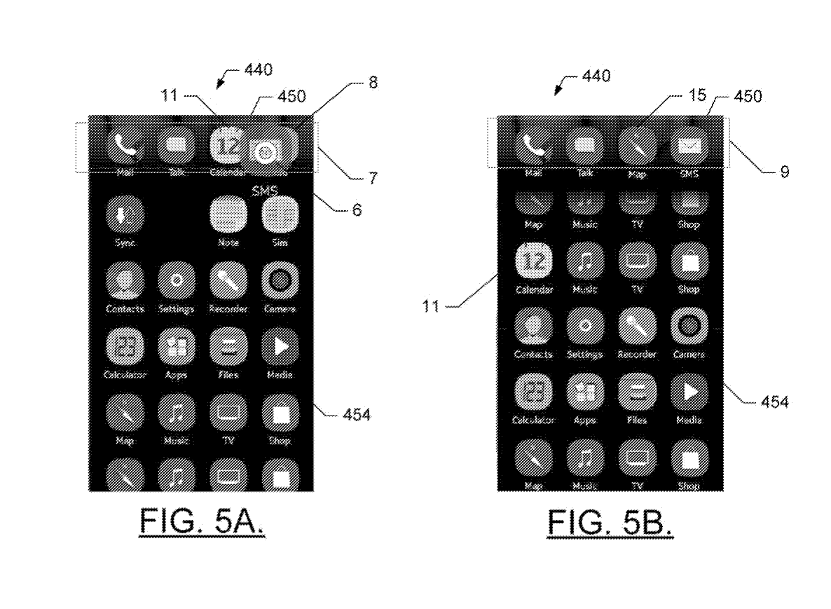

Referring now to FIGS. 5A and 5B, diagrams illustrating views of user interfaces according to an example embodiment is provided. In the example embodiment of FIG. 5A, a merging area module (e.g., merging area module 78) of an apparatus 440 (e.g., apparatus 40) may enable items of visible indicia (e.g., an icon(s)) of the merging area 7 to be switched with items of visible indicia (e.g., an icon(s)) of another area or space (e.g., a main menu, an application view) of touch screen interface 454 (e.g., touch screen interface 54). The merging area 7 and the other area or space of the touch screen interface 454 may be shown via the touch screen display 450 (e.g., touch screen display 50).

For example, the merging area module may detect a selection by a pointer of an item of visible indicia 6 associated with a SMS (also referred to herein as SMS icon 6) and may move the SMS icon 6 over an item of visible indicia 8 associated with an information application (also referred to herein as info icon 8) of the merging area 7 in response to detection of the pointer moving the SMS icon 6 over the info icon 8. In this regard, upon detection of the SMS icon 6 being released over the info icon 8, the merging area module may replace the info icon 8 of the merging area 7 with the SMS icon 6. As such, the merging area module may automatically move the info icon 8 to the previous location of the SMS icon 8 in an area or space (e.g., a main menu) of the touch screen interface 454.

In the example embodiment of FIG. 5B, a merging area module of an apparatus 440 (e.g., apparatus 40) may replace an item of visible indicia 11 associated with a calendar application (also referred to herein as calendar icon 11), of a merging area (e.g., merging area 9), with an item of visible indicia 15 associated with a map application (also referred to herein as map icon 15). The merging area module may replace the calendar icon 11 with the map icon 15 in an instance in which the merging area module detects a selection of the map icon 15 being moved by a pointer over the calendar icon 11 and released. In this regard, the merging area module may automatically move the calendar icon 11 from the merging area 9 to an area or space of (e.g., a main menu) of the touch screen interface 454 previously occupied by the map icon 15.

In the example embodiment of FIG. 5B, the merging area module 9 may, but need not, be part of a new screen or view (e.g., a previous or subsequent screen) of the touch screen interface 454 with respect to the view of FIG. 5A, for example. For instance, the arrangement of items of visible indicia (e.g., icons) of the touch screen interface 454 of FIG. 513 are different with respect to FIG. 5A which may indicate in this example that the screen/view of FIG. 5B is a newly accessed and a different screen from FIG. 5A. However, the merging area of FIG. 5B remains intact in a top portion of the screen with reference to FIG. 5A, even though a new screen may be accessed.

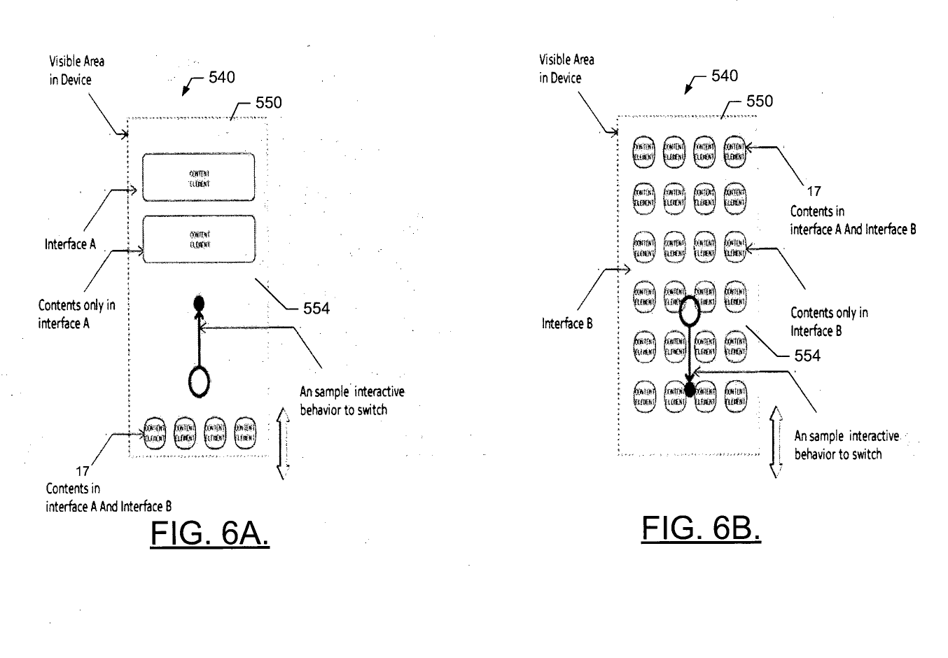

Referring now to FIGS. 6A and 6B, diagrams illustrating user interfaces according to an example embodiment is provided. In the example embodiment of FIG. 6A, the apparatus 540 may include an interface area A and interface area B that are part of touch screen interface 554. The interface A may include one or more content element 19 and 21 (e.g., widgets). Additionally, in the example embodiment of FIG. 6A, merging area 17 (e.g., merging area 5) may include content elements (e.g., items of visible indicia (e.g., icons)) in interface A and interface B of the touch screen interface 554.

In the example embodiment of FIG. 6B, the merging area 17 may be moved by a merging area module (e.g., merging area module 78) of the apparatus 540 to a top portion of the touch screen interface 554. In this example embodiment, the top portion of the touch screen interface 554 may correspond or overlap with an area of an interface A and an interface B.

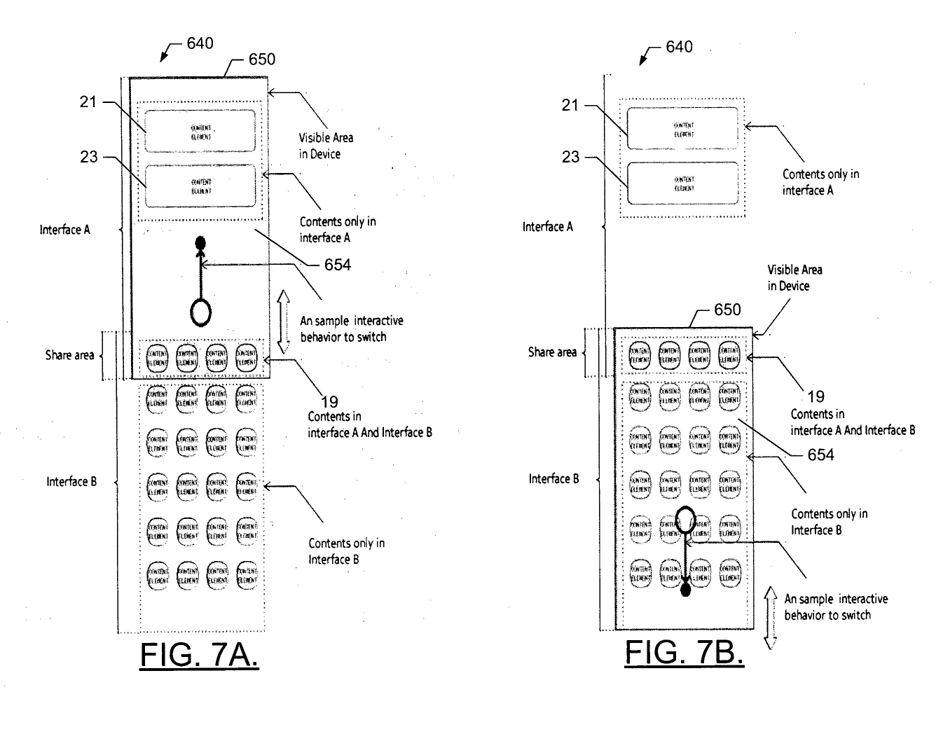

Referring now to FIGS. 7A and 7B, diagrams illustrating user interfaces according to an example embodiment are provided. In the example embodiment of FIG. 7A, the touch screen interface 654 (e.g., touch screen interface 54) of the apparatus 640 may include an interface A and an interface B. In the example embodiment of FIG. 7A, the interface A of the touch screen interface 654 may be shown on the touch screen display 650 (e.g., touch screen display 50). However, the interface B of the touch screen interface 654 may be off the screen and outside of the viewable portion of the touch screen display 650. The content elements 21, 23 may be items of visible indicia such as, for example, widgets. The merging area 19 (also referred to herein as share area 19) (e.g., merging area 5) may be in a common or shared area and may overlap portions of the interface A and the interface B of the touch screen interface 654. In this regard, the merging area 19 of FIG. 7A may be between upper and lower interfaces (e.g., interfaces A and B) of the touch screen interface 654 and the merging area 19 may be utilized to enable sharing of objects and functions between the upper and lower interfaces.

In the example embodiment of FIG. 7B, the merging area module of the apparatus 650 may move the interface B into the viewable area of the touch screen display 650 in response to a receipt of a selection by a pointer moving the portion of the interface B into the visible area of the touch screen display 650. As such, in this example embodiment, the interface A of the touch screen interface 654 may be outside of the viewable area of the touch screen display 650. Even though the interface area A is moved by the merging area module into the visible portion of the display, the merging area 19 may remain intact in a same position and may also be in the visible portion of the touch screen display 650.

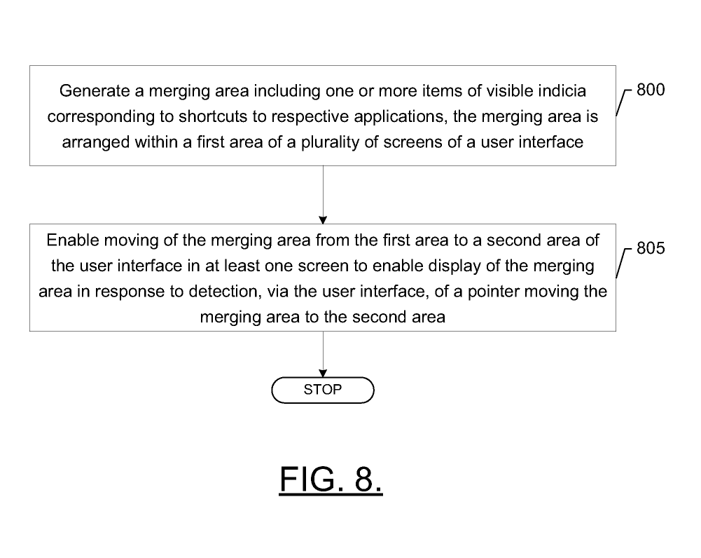

Referring now to FIG. 8, an example embodiment of a flowchart for providing a user-friendly and reliable manner in which to manage objects of a user interface is provided. At operation 800, an apparatus (e.g., apparatus 40) may include means such as the processor 52, the merging area module 78 and/or the like, for generating a merging area (e.g., merging area 5) including one or more items of visible indicia (e.g., icons) corresponding to shortcuts to respective applications. The merging area is arranged within a first area of a plurality of screens of a user interface (e.g., touch screen interface 54). At operation 805, the apparatus (e.g., apparatus 40) may include means such as the processor 52, the detector 60, the merging area module 78 and/or the like, for enabling moving of the merging area from the first area to a second area of the user interface (e.g., touch screen interface 54) in at least one screen (e.g., a home screen, a main menu) of the screens to enable display (e.g., via touch screen display 50) of the merging area in response to detection, via the user interface, of a pointer moving the merging area to the second area.

It should be pointed out that FIG. 8 is a flowchart of a system, method and computer program product according to an example embodiment of the invention. It will be understood that each block of the flowchart, and combinations of blocks in the flowchart, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory device 58) and executed by a processor (e.g., processor 52, merging area module 78). As will be appreciated, any such computer program instructions may be loaded onto a computer or other programmable apparatus (e.g., hardware) to produce a machine, such that the instructions which execute on the computer or other programmable apparatus cause the functions specified in the flowchart blocks to be implemented. In one embodiment, the computer program instructions are stored in a computer-readable memory that can direct a computer or other programmable apparatus to function in a particular manner, such that the instructions stored in the computer-readable memory produce an article of manufacture including instructions which implement the function(s) specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart blocks.

Accordingly, blocks of the flowchart support combinations of means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In an example embodiment, an apparatus for performing the method of FIG. 8 above may comprise a processor (e.g., the processor 52, the merging area module 78) configured to perform some or each of the operations (800-805) described above. The processor may, for example, be configured to perform the operations (800-805) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (800-805) may comprise, for example, the processor 52 (e.g., as means for performing any of the operations described above), the merging area module 78, the detector 60 and/or a device or circuitry for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
generating, via a processor, a merging area comprising one or more items of visible indicia corresponding to shortcuts to respective applications, the merging area is arranged within a first area of a plurality of screens of a user interface; and
enabling moving of the merging area from the first area to a second area of the user interface in at least one screen of the screens to enable display of the merging area in response to detection, via the user interface, of a pointer moving the merging area to the second area.

2. (canceled)

3. The method of claim 1, wherein the second area is an area of the user interface other than a bottom section of the screen of the user interface.

4. The method of claim 3, wherein the merging area is positioned in the second area in the plurality of screens to maintain continuity of the merging area in the screen and the plurality of screens.

5. The method of claim 4, further comprising:
enabling display of the merging area in the position of the second area in response to accessing one of the plurality of screens.

6. The method of claim 1, wherein the second area is an upper or lower area of the user interface with respect to the first area.

7. The method of claim 5, wherein the accessed screen comprises a screen that precedes the at least one screen or is subsequent to the at least one screen.

8. The method of claim 1, wherein the at least one screen comprises a home screen.

9. (canceled)

10. (canceled)

11. (canceled)

12. (canceled)

13. (canceled)

14. (canceled)

15. An apparatus comprising:
at least one processor; and
at least one memory including computer program code, the at least one memory and the computer program code configured to, with the at least one processor, cause the apparatus to perform at least the following:
generate a merging area comprising one or more items of visible indicia corresponding to shortcuts to respective applications, the merging area is arranged within a first area of a plurality of screens of a user interface; and
enable moving of the merging area from the first area to a second area of the user interface in at least one screen of the screens to enable display of the merging area in response to detection, via the user interface, of a pointer moving the merging area to the second area.

16. (canceled)

17. The apparatus of claim 15, wherein the second area is an area of the user interface other than a bottom section of the screen of the user interface.

18. The apparatus of claim 17, wherein the at least one memory and the computer program code are further configured to, with the processor, cause the apparatus to:
position the merging area in the second area in the plurality of screens to maintain continuity of the merging area in the screen and the plurality of screens.

19. The apparatus of claim 18, wherein the at least one memory and the computer program code are further configured to, with the processor, cause the apparatus to:
enable display of the merging area in the position of the second area in response to accessing one of the plurality of screens.

20. (canceled)

21. The apparatus of claim 19, wherein the accessed screen comprises a screen that precedes the at least one screen or is subsequent to the at least one screen.

22. The apparatus of claim 15, wherein the at least one screen comprises a home screen.

23. The apparatus of claim 22, wherein the home screen comprises a screen of a user interface that is initially enabled for display via the apparatus of the user interface in an instance in which the apparatus is turned on and which may remain as an active screen of the user interface even after the apparatus is turned on.

24. The apparatus of claim 15, wherein the second area comprises a commonly shared area of a first section of the user interface comprising one or more content elements and a second section of the user interface comprising additional content elements.

25. The apparatus of claim 15, wherein the at least one memory and the computer program code are further configured to, with the processor, cause the apparatus to;
replace a first item of visible indicia of the merging area with a second item of visible indicia being moved from a location of the user interface and placed over the first item of visible indicia of the merging area.

26. The apparatus of claim 25, wherein the at least one memory and the computer program code are further configured to, with the processor, cause the apparatus to:
automatically place the replaced first item of visible indicia in the location of the second item of visible indicia that was moved in response to placing the second item of visible indicia over the first item of visible indicia of the merging area.

27. The apparatus of claim 15, wherein the items of visible indicia comprise icons,

28. The apparatus of claim 15, wherein the applications are designated as default applications or favorite applications of a user of the user interface.

29. A computer program product comprising at least one non-transitory computer-readable storage medium having computer-executable program code instructions stored therein, the computer-executable program code instructions comprising:
program code instructions configured to generate a merging area comprising one or more items of visible indicia corresponding to shortcuts to respective applications, the merging area is arranged within a first area of a plurality of screens of a user interface; and
program code instructions configured to enable moving of the merging area from the first area to a second area of the user interface in at least one screen of the screens to enable display of the merging area in response to detection, via the user interface, of a pointer moving the merging area to the second area.

30. (canceled)

31. (canceled)
